(19) United States
(12) Patent Application Publication
(10) Pub. No.: US 2011/0080299 A1
(43) Pub. Date: Apr. 7, 2011

(54) EMERGENCY POWER ACTIVATION DEVICE

(75) Inventors: Wen-Hua Lin, Yilan County (TW); Yun-Yuan Chu, Taipei (TW)

(73) Assignees: NATIONAL ENERGY TECHNOLOGY CO., LTD., Tucheng City (TW); APOGEE POWER, INC., Campbell, CA (US); ORCHARD ELECTRONICS COMPANY LTD., Xindian City (TW)

(21) Appl. No.: 12/683,435

(22) Filed: Jan. 7, 2010

(30) Foreign Application Priority Data
Oct. 1, 2009 (TW) 098133466

(51) Int. Cl. G08B 21/00; H02J 9/00

(52) U.S. Cl. 340/657; 307/66

(57) ABSTRACT

An emergency power activation device includes at least one power module and a main control module. Each of the at least one power module includes an output end. The main control module includes an interface unit and a monitoring unit. When the interface unit is electrically connected with the power module, the electric energy stored in the power module can be outputted to the output end. The monitoring unit monitors the power storage of the power module and the electric connection between the power module and the main control module in real time. In this way, the emergency power activation device can keep the power supply stable while on standby for a long time and monitor the storage of its internal electric energy for an emergency power generator.

### BACKGROUND OF THE INVENTION

1. Field of the Invention

The present invention relates generally to power supply systems and, more particularly, to an emergency power activation device.

2. Description of the Related Art

In consideration of fire prevention and safety, at least one emergency power generator is usually installed in a building for immediate power supply for general illumination or emergency facility inside the building while a blackout or power failure happens.

A conventional emergency power generator usually uses a lead-acid battery for actuation and initial operation and then continues to generate electricity by operation of its own engine.

The aforesaid emergency power generator and the lead-acid battery are idle in normal time and will not be used unless a power failure occurs. However, the self-discharging rate of the lead-acid battery is more than 20%, such that the battery has a short cycle life and needs a long charging time. For this reason, it often happens that the lead-acid battery is dead or its power is too low to activate the emergency power generator when it is needed; as a result, it may jeopardize the safety of the building or do damage to people or assets.

### SUMMARY OF THE INVENTION

The primary objective of the present invention is to provide an emergency power activation device, which can keep power supply stable while on standby for a long time.

The secondary objective of the present invention is to provide an emergency power activation device, which can monitor the storage of its internal electric energy.

The foregoing objectives of the present invention are attained by the emergency power activation device composed of at least one power module and a main control module. Each of the at least one power module includes an output end. The main control module includes an interface unit and a monitoring unit. When the interface unit is electrically connected with the power module, the electric energy stored in the power module can be outputted to the output end. The monitoring unit monitors the status of power storage of the power module and of electric connection between the power module and the main control module in real time.

### BRIEF DESCRIPTION OF THE DRAWINGS

FIG. 1 is a block diagram of a preferred embodiment of the present invention.

### DETAILED DESCRIPTION OF PREFERRED EMBODIMENTS

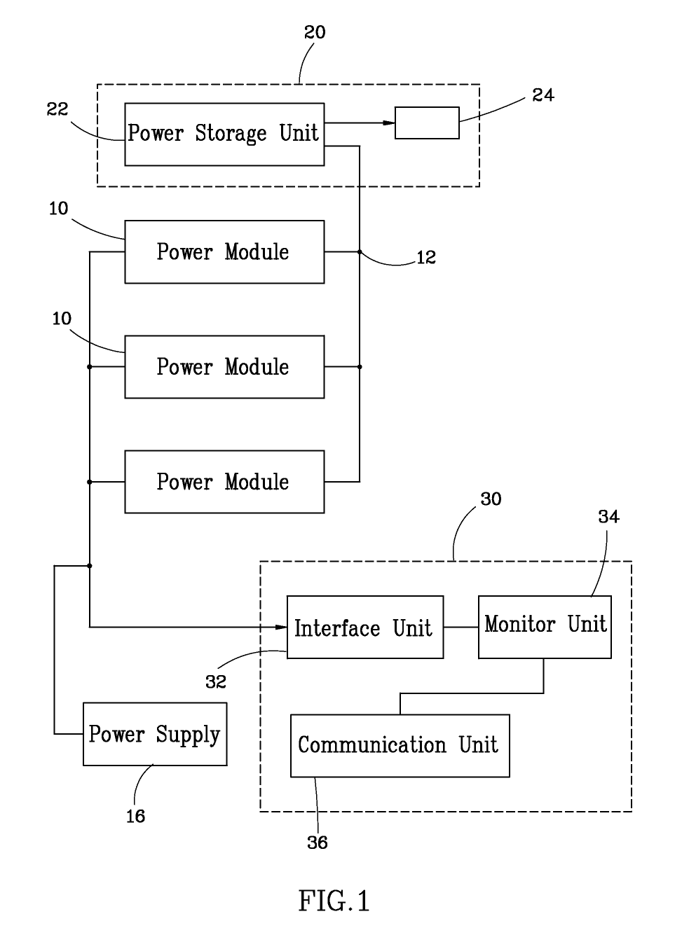

Referring to FIG. 1, an emergency power activation device constructed according to a preferred embodiment of the present invention is composed of at least one power module 10, an electric energy output module 20, and a main control module 30.

There are three power modules 10 in this embodiment. Each of the power modules 10 includes a plurality of battery units made of LiFePO₄. The electric energy stored in each of the battery units can be outputted to an output end 12 of the power module 10.

The electric energy output module 20 includes a power storage unit 22 and an output end 24. The power storage unit 22 is a supercapacitor, each metallic electrode of which is coated with a metallic thin layer, like molybdenum nitride, iron nitride, or titanium nitride, thus being capable of immediate charging and discharging, storing electric energy of high capacity, and outputting high current and power. The power modules 10 and the power storage unit 22 are electrically connected with the output end 24 in parallel for transmitting the electric energy stored in the power modules 10 to the output end 24 of the electric energy output module 20 via the power storage unit 22, further powering the motor starters of various power generators (not shown).

The main control module 30 includes an interface unit 32, a monitoring unit 34, and a communication unit 36, which are electrically connected with one another. When the interface unit 32 is electrically connected with the power module 10, the electric energy stored in the power modules 10 can be controlled for output to the electric energy output module 20. The monitoring unit 34 monitors the status of storage of electric energy in the power modules 10 and of the electric connection between the power modules 10 and the main control module 30 in real time. The communication unit 36 transmits signals indicating various circumstances monitored by the monitoring unit 34 to a remote terminal for remote surveillance and maintenance call. The communication unit 36 can transmit signals by wired or wireless communication, e.g. by means of ISDN (Integrated Services Digital Network), GPRS (General Packet Radio Service) or WLAN (Wireless Local Area Network).

When the present invention is applied to various emergency power generators, as long as the output end 24 of the electric energy output module 20 is electrically connected with the motor starter of one of the power generators, the electric energy stored in the power modules 10 can be outputted through the power storage unit 22 to the motor starter for driving the power generator for operation. Because the power storage unit 22 can output higher energy density and higher power density, strong current can be provided for the emergency power generator in need of high power. Besides, each of the battery units of the power modules 10 is made of LiFePO₄ to have a long working life and a discharge rate smaller than 8%, which enables the battery unit to still have sufficient power, even after it has been idle or dormant for a long time, such that it is applicable to the emergency power generator.

Each of the power modules 10 must be connected with the interface unit 32 of the main control module 30 before the electric energy of the power module 10 is outputted to the output end 24. As soon as the electric energy of the power modules 10 is outputted to the output end 24, the monitoring unit 34 can monitor the power storage of the power modules 10. When any of the power modules 10 functions abnormally, e.g. when it has low power or is damaged, the monitoring unit 34 can immediately detect the abnormality and then cut out the abnormal power module 10; meanwhile, the communication unit 35 can transmit the abnormality to a remote terminal for maintenance personnel to deal with the abnormality, e.g. the maintenance personnel can replace the abnormal power module 10 with a new one. After the new power module 10 is connected with the interface unit 32, the monitoring unit 34 can detect the voltage of the new power module 10. If the voltage of the new power module 10 is significantly different from those of the other power modules 10, the monitor 34 will temporally disable the new power module 10 from parallel connection with the electric energy output module 20; after the voltage of all of the power modules 10 are consistent with one another, the monitoring unit 34 will then enable the new power module 10 to be connected in parallel with the electric energy output module 20. After the voltage of all of the power modules reach the same, the new power module 10 can be connected with the electric energy output module 20 in parallel. This will prevent the new power module 10 of low voltage from the danger of explosion resulting from charging at strong current by other power modules 10. When any of the power modules 10 and the interface unit 32 are open-circuit therebetween, the other power modules 10 are unaffected and will provide additional power for compensation. Therefore, the present invention can actively send out a warning, even if something abnormal happens in the normal idle time, and keep the power supply stable for a long time.

Although the present invention has been described with respect to a specific preferred embodiment thereof, it is in no way limited to the specifics of the illustrated structures but changes and modifications may be made within the scope of the appended claims.

What is claimed is:

1. An emergency power activation device comprising:
at least one power module each having an output end; and
a main control module having an interface unit and a monitoring unit; whereby when the interface unit is electrically connected with the at least one power module, electric energy stored in the at least one power module is outputted to the output end and the monitoring unit monitors voltage of power storage of the at least one power module and controls electric connection between the power module and the main control module.

2. The emergency power activation device as defined in claim 1, wherein the main control module further comprises a communication unit for transmitting signals indicating various circumstances monitored by the monitoring unit to a remote terminal.

3. The emergency power activation device as defined in claim 1, wherein each of the at least one power module comprises a plurality of battery units made of a compound containing lithium.

4. The emergency power activation device as defined in claim 1, further comprising an electric energy output module, wherein the electric energy output module is electrically connected in parallel with the output end of the at least one power module.

5. The emergency power activation device as defined in claim 4, wherein the electric energy output module comprises a power storage unit that is a supercapacitor with metallic electrodes coated with molybdenum nitride, iron nitride, or titanium nitride.

6. The emergency power activation device as defined in claim 4, wherein the at least one power module includes a plurality of power modules; the monitor unitmonitoring unit is provided for detecting a voltage of the power modules; when the voltage of one of the power modules is relatively low, the monitoring unit disables the power module having the lowest voltage from connection with the electric energy output module.
